(19) United States
(12) Patent Application Publication
(10) Pub. No.: US 2013/0009399 A1
(43) Pub. Date: Jan. 10, 2013

(54) WASTE HEAT RECOVERY

(76) Inventor: Kevin L. BROWN, Reston, VA (US)

(21) Appl. No.: 13/544,302

(22) Filed: Jul. 9, 2012

Related U.S. Application Data
(60) Provisional application No. 61/505,862, filed on Jul. 8, 2011.
(60) Provisional application No. 61/505,855, filed on Jul. 8, 2011.
(60) Provisional application No. 61/505,842, filed on Jul. 8, 2011.
(60) Provisional application No. 61/548,455, filed on Oct. 18, 2011.
(60) Provisional application No. 61/577,977, filed on Dec. 20, 2011.
(60) Provisional application No. 61/635,441, filed on Apr. 19, 2012.
(60) Provisional application No. 61/668,662, filed on Jul. 6, 2012.

(51) Int. Cl. H02K 7/18; F28D 15/00

(52) U.S. Cl. 290/52; 165/104.21

(57) ABSTRACT

A method and apparatus for a vacuum tube configured to produce heat during operation. A boiler is configured to hold a fluid used to cool at least a portion of the vacuum tube during operation, wherein the fluid, when used to cool at least the portion of the vacuum tube, produces vapor. A turbine is configured to receive at least a first portion of the vapor produced when the fluid is used to cool at least the portion of the vacuum tube, wherein the turbine, when at least the first portion of the vapor produced when the fluid is used to cool at least the portion of the vacuum tube is received, is further configured to convert into electrical energy at least the first portion of the vapor produced when the fluid is used to cool at least the portion of the vacuum tube.

### RELATED CASES

This application claims the benefit of U.S. Provisional Application No. 61/505,862 filed on 8 Jul. 2011, U.S. Provisional Application No. 61/505,855 filed on 8 Jul. 2011, U.S. Provisional Application No. 61/505,842 filed on 8 Jul. 2011, U.S. Provisional Application No. 61/548,455 filed on 18 Oct. 2011, U.S. Provisional Application No. 61/577,977 filed on 20 Dec. 2011, U.S. Provisional Application No. 61/635,441 filed on 19 Apr. 2012, and U.S. Provisional Application No. 61/668,662 filed on 6 Jul. 2012, the contents of which are all incorporated by reference.

### TECHNICAL FIELD

This disclosure relates to waste heat recovery.

### BACKGROUND

During operation, some devices may produce heat. Too much heat may cause damage to certain parts of the device. As such, generally, systems desiring to remove the heat produced during operation simply release the heat into the local environment. Thus, the heat produced by the device is not used, but is instead wasted.

### SUMMARY OF DISCLOSURE

In one implementation, an apparatus comprises a device configured to produce heat during operation. A first container is configured to hold a fluid used to cool at least a portion of the device during operation, wherein the fluid, when used to cool at least the portion of the device, produces vapor. An electrical generating device is configured to receive at least a first portion of the vapor produced when the fluid is used to cool at least the portion of the device, wherein the electrical generating device, when at least the first portion of the vapor produced when the fluid is used to cool at least the portion of the device is received, is further configured to convert into electrical energy at least the first portion of the vapor produced when the fluid is used to cool at least the portion of the device.

One or more of the following features may be included. A second container may be configured to hold at least the first portion of the vapor produced when the fluid is used to cool at least the portion of the device, wherein the second container may include a control valve configured to force into the electrical generating device at least the first portion of the vapor produced when the fluid is used to cool at least the portion of the device. A path may be configured to return at least a portion of condensed vapor produced from at least the first portion of the vapor back to the first container. A path may be configured to allow at least a portion of condensed vapor produced from at least the first portion of the vapor escape from the electrical generating device. At least the first portion of the vapor produced when the fluid is used to cool at least the portion of the device may be reheated before the electrical generating device receives at least the first portion of the vapor produced when the fluid is used to cool at least the portion of the device. One or more couplings may be configured to drive a load via the device. The load may include at least one of a generator, a motor, and an alternator.

In another implementation, an apparatus comprises a vacuum tube configured to produce heat during operation. A boiler is configured to hold a fluid used to cool at least a portion of the vacuum tube during operation, wherein the fluid, when used to cool at least the portion of the vacuum tube, produces vapor. A turbine is configured to receive at least a first portion of the vapor produced when the fluid is used to cool at least the portion of the vacuum tube, wherein the turbine, when at least the first portion of the vapor produced when the fluid is used to cool at least the portion of the vacuum tube is received, is further configured to convert into electrical energy at least the first portion of the vapor produced when the fluid is used to cool at least the portion of the vacuum tube.

One or more of the following features may be included. A reservoir may be configured to hold at least the first portion of the vapor produced when the fluid is used to cool at least the portion of the vacuum tube, wherein the reservoir may include a control valve configured to force into the turbine at least the first portion of the vapor produced when the fluid is used to cool at least the portion of the vacuum tube. A path may be configured to return at least a portion of condensed vapor produced from at least the first portion of the vapor back to the boiler. A path may be configured to allow at least a portion of condensed vapor produced from at least the first portion of the vapor escape from the turbine. At least the first portion of the vapor produced when the fluid is used to cool at least the portion of the vacuum tube may be reheated before the turbine receives at least the first portion of the vapor produced when the fluid is used to cool at least the portion of the vacuum tube. One or more couplings may be configured to drive a load via the vacuum tube. The load may include at least one of a generator, a motor, and an alternator.

In another implementation, a method comprises producing heat from a device during operation. A fluid used to cool at least a portion of the device during operation is held in a first container, wherein the fluid, when used to cool at least the portion of the device, produces vapor. An electrical generation device receives at least a first portion of the vapor produced when the fluid is used to cool at least the portion of the device. At least the first portion of the vapor produced when the fluid is used to cool at least the portion of the device is converted into electrical energy, at least in part by the electrical generation device when at least the first portion of the vapor produced when the fluid is used to cool at least the portion of the device is received.

One or more of the following features may be included. At least the first portion of the vapor produced when the fluid is used to cool at least the portion of the device may be held and at least the first portion of the vapor produced when the fluid is used to cool at least the portion of the device may be forced into the electrical generation device. At least a portion of condensed vapor produced from at least the first portion of the vapor may be returned back to the first container. At least a portion of condensed vapor produced from at least the first portion of the vapor may be allowed to escape from the electrical generation device. Before the electrical generation device receives at least the first portion of the vapor produced when the fluid is used to cool at least the portion of the device, at least the first portion of the vapor produced when the fluid is used to cool at least the portion of the device may be reheated. One or more couplings may drive a load via the device. The load may include at least one of a generator, a motor, and an alternator.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an illustrative diagrammatic view of an example vacuum tube according to one or more embodiments of the disclosure;

FIG. 2 is an illustrative diagrammatic view of one or more embodiments of the disclosure;

FIG. 3 is an illustrative diagrammatic view of one or more embodiments of the disclosure;

FIG. 4 is an illustrative diagrammatic view of one or more embodiments of the disclosure; and

FIG. 5 is an illustrative flowchart of a process of one or more embodiments of the disclosure.

Like reference symbols in the various drawings indicate like elements.

### DETAILED DESCRIPTION OF THE EMBODIMENTS

### System Overview:

Generally, waste heat from, e.g., electrical systems, may be at low temperatures of only a few hundreds of ° C., as may be typical for semiconductor devices, and widely distributed in space among the various components of the electrical apparatus or system. However, if waste heat were generated at higher temperatures and in more concentrated volumes of space, the unwanted heat may be captured and efficiently converted to other forms of energy or for other uses. For instance, as will be discussed in greater detail below, according to one or more embodiments, a vacuum tube may be used as a power handling element, and waste heat from the vacuum tube may be used to create steam to drive an electrical generator to produce electricity, which may then be reused. The high-temperature, concentrated heat that may be produced by vacuum tubes as a by-product, at least a portion of which may otherwise be wasted, may be usefully recovered.

For example, according to one or more embodiments, one or more vacuum tubes may operate at very high temperatures and may produce high-temperature waste heat in a geometrically small space. In the example, this situation may provide an opportunity to use this heat to create, e.g., super-heated steam (or other working fluid) to drive, in some embodiments, a turbine. The turbine may in turn drive an electrical generator, such as an alternator, to produce electricity. The electricity may then, for example, be fed back to the electrical power source which a regulator may be regulating, be used to power other electrically driven loads or stored in an electrical energy storage device (e.g., capacitor, battery, etc.).

The working fluid used to extract heat from a vacuum tube may, for example, a coolant for the vacuum tube. Depending upon the design, vacuum tubes may operate at, e.g., >1000° C. at their anode, collector or “plate”, so a large temperature difference ΔT may be established between a hot reservoir (i.e., the region of the vacuum tube) and a cold reservoir (i.e., the region near an exit of the electrical generator), which may improve the efficiency of energy extraction.

According to one or more embodiments, as will be discussed in greater detail below, the working fluid may undergo a reversible liquid-gas-liquid phase change, being a gas (e.g., steam) after being heated by the vacuum tube and condensing to a liquid (e.g., water) after passing through one or more portions of an electrical generating device (e.g., a turbine). Such phase changes may dramatically increase the quantity of heat that may be transferred per quantity of working fluid, due to the latent heat of vaporization and condensation, which may result in a smaller and lighter system, for example.

According to one or more embodiments, as will be discussed in greater detail below, a closed piping device may be used, at least in part, for the working fluid, closed in the sense of confining pressures of gases or liquids above ˜1 atmosphere from escaping to lower pressure regions. According to one or more embodiments, a pump or other devices may be provided to increase the pressure in a fluid pipe, a containment vessel or other conveyance means for the superheated steam or fluid. According to one or more embodiments, the working fluid may be re-circulated within a closed fluid circuit.

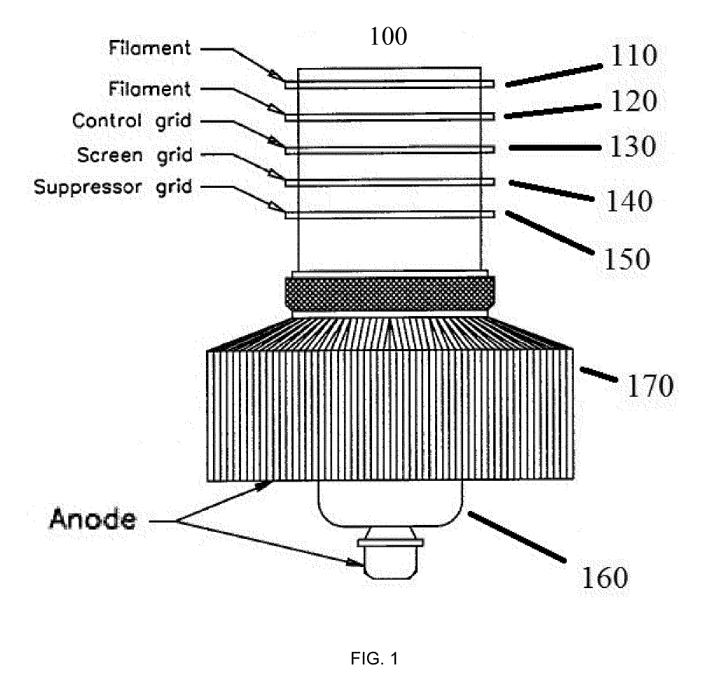

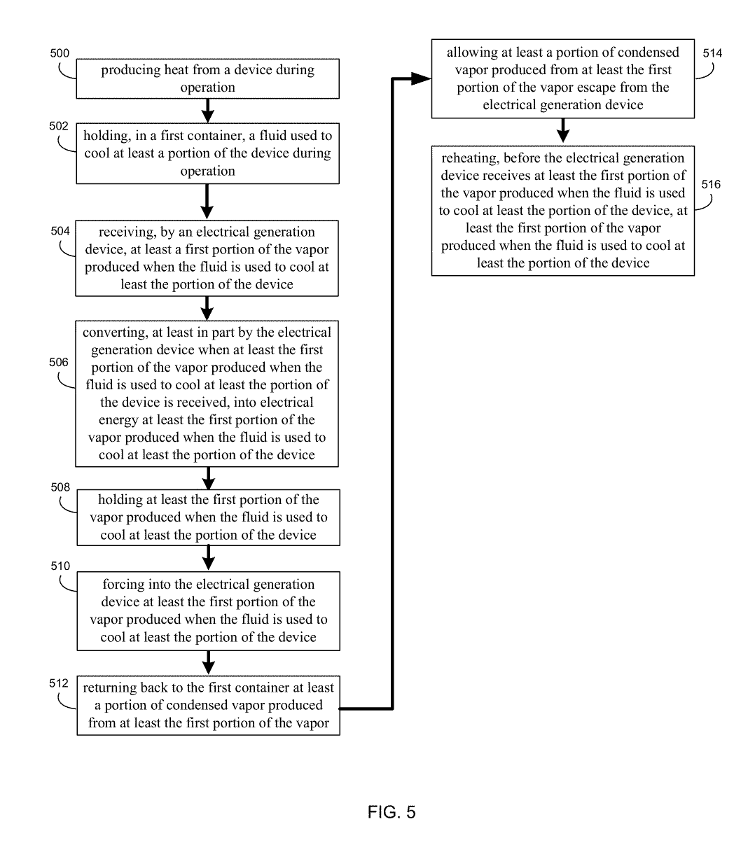

As discussed above and referring also to FIGS. 1-5, an apparatus may comprise a device (e.g., vacuum tube 100) that may be configured to produce 500 heat during operation. For example, according to one or more embodiments, and referring at least to FIG. 1, an example vacuum tube is shown. FIG. 1 illustrates a 1.5 megawatt (MW) vacuum tube 100, which may be commercially available as a Svetlana model 5CX1500B. The particular model shown may be designed for forced-air-flow cooling, but equivalent fluid-cooled models may be available. While vacuum tube 100 may be considered rugged and suitable for driving many industrial and transport related loads, up to 30% of its rated power may be lost as heat, which may be ˜0.45 MW. In operation, an electron-emissive filament or tungsten mesh cathode connected between terminals (e.g., filaments 110 and 120) may be heated to thermionic emission temperatures, and electrons liberated may be controllably accelerated toward anode (e.g., anode 160) by electric potentials on the order of, e.g., 10-100 kV and higher. The various grids (e.g., grids 130, 140 and 150) inside vacuum tube 100 may be biased at settable potentials to control the amount of electron current received at anode 160, thereby enabling vacuum tube 100 to function as, e.g., an amplifier, switch, pulser, etc.

Waste heat produced by vacuum tube 100 may result from the collection of, e.g., the electrons with 10-100 kV and higher kinetic energy at anode 160, also sometimes called the collector or plate. This heat may be dissipated directly into the metal anode structure, and it may be removed or it may melt or otherwise permanently degrade anode 160. Using such vacuum tubes (e.g., such as high-power radio and radar transmission) as cooling systems to cool anode 160 and its cooling structure (e.g., cooling structure 170) of such vacuum tubes may be used with water that boils to steam for transport of the heat away from the tubes. Examples of such vacuum tube cooling systems may be described in J.C. Whitaker, Power Vacuum Tubes Handbook, 2nd Edition (CRC Press, Boca Raton, Fla. USA, 1999), pp. 112-116.

While a vacuum tube is described in one or more embodiments, those skilled in the art will appreciate that other power handling elements or other devices that require cooling may also be used. As such, the use of vacuum tube 100 should be taken as an example only and not to otherwise limit the scope of the disclosure.

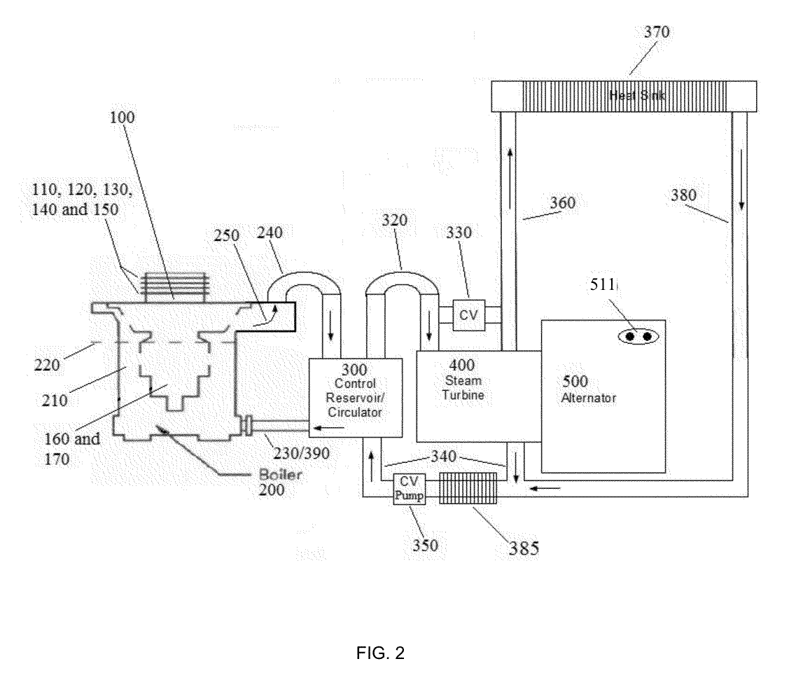

According to one or more embodiments, a first container (e.g., boiler 200) may be configured to hold 502 a fluid (e.g., liquid working fluid 210) used to cool vacuum tube 100 during operation, wherein liquid working fluid 210, when used to cool vacuum tube 100, may produce vapor (e.g., vapor 250). For example, and referring at least to FIG. 2, vacuum tube 100 may be mounted and partially inserted into boiler 200, and the mounting connection may be sealed against escape of vapor 250 by known techniques.

According to one or more embodiments, a plurality of vacuum tubes 100, of similar and/or different design and function, may all be mounted to and share a common reservoir/boiler 200. Vacuum tube 100 may generally have cylindrical symmetry, the axis of the cylinder (not shown) may be vertical and in the plane of FIG. 2, as illustrated. An initially liquid working fluid 210, such as water, may fill boiler 200, e.g., up to a level (e.g., level 220) which may assure that anode 160 and anode cooling structure 170 of vacuum tube 100 are immersed in liquid working fluid 210.

According to one or more embodiments, a second container (e.g., control reservoir 300) may be configured to hold 508 vapor 250 produced when liquid working fluid 210 is used to cool vacuum tube 100. For example, heat from vacuum tube 100 may vaporize fluid 210 to produce vapor 250, such as steam, which may be piped through a path (e.g., path 240) to a control reservoir (e.g., control reservoir 300). Control reservoir 300 may include a control valve (e.g., control valve 330) configured to force 510 into turbine 400 vapor 250 produced when liquid working fluid 210 is used to cool vacuum tube 100.

According to one or more embodiments, an electrical generating device (e.g., turbine 400) may be configured to receive 504 vapor 250 produced when liquid working fluid 210 is used to cool vacuum tube 100. Turbine 400, when vapor 250 produced when the fluid is used to cool vacuum tube 100 is received, may be further configured to convert 506 into electrical energy vapor 250 produced when liquid working fluid 210 is used to cool vacuum tube 100. For example, when it is desired to produce electrical power from vapor 250, control valve 330 (which may reside inside control reservoir 300) may be opened to pipe 320 while bypass control valve 330 may be closed, thus forcing 510 vapor 250 at high pressure into turbine 400. Turbine 400 may spin and drive an alternator (e.g., alternator 500) to produce electricity at output terminals (e.g., output terminals 511).

While one or more embodiments may describe forcing 510 vapor 250 into turbine 400 from control reservoir 300, those skilled in the art will appreciate that it may be possible to force 510 vapor 250 into turbine 400 using any path (e.g., directly from boiler 200) without departing from the scope of the disclosure. As such, any description of the specific path used to force 510 vapor 250 into turbine 400 should be taken as an example only and not to otherwise limit the scope of the disclosure.

According to one or more embodiments, alternating current (AC) from terminals 511 may be conducted to an electrical power conditioning system in which the AC may be rectified to direct current (DC) and used to charge one or more energy storage devices (e.g., capacitors, batteries, etc.), with an interposed regulating circuit to manage voltage and current levels. This may allow turbine 400 to spin at a wide variety of shaft speeds and still produce usable electrical power, which may improve the efficiency of systems applying one or more aspects of the disclosure.

According to one or more embodiments, a path (e.g., pipe 340) may be configured to return 512 back to boiler 200 at least a portion of condensed vapor produced from vapor 250. For example, at least some of vapor 250, which may include steam, may condense in turbine 400 and may be collected as a resultant liquid by pipe 340 and returned 512 to, e.g., control reservoir 300, e.g., via gravity and/or optionally a pump (e.g., pump 350). However, those skilled in the art will appreciate that the liquid may be returned 512 directly to boiler 200.

According to one or more embodiments, remaining vapor 250 may be directed through a path (e.g., pipe 360) to a radiator (e.g., radiator 370) where vapor 250 may be condensed, and the resultant liquid may be returned 512 to control reservoir 300 via a path (e.g., pipe 380), e.g., via gravity and/or optionally pump 350.

According to one or more embodiments, a path (e.g., pipe 340) may be configured to allow 514 at least a portion of condensed vapor produced from vapor 250 to escape from turbine 400. For example, turbine 400 may be operated with non-condensing and/or partially condensing vapor 250 exiting from turbine 400 at pipe 340, for example, there being so little heat remaining to be removed from liquid working fluid 210 that a larger sized radiator (e.g., radiator 370) may not be necessary. According to one or more embodiments, in that case, one or more valves may be used to direct the effluent vapor 250 through a path (e.g., pipe 340) into a smaller radiator or heat exchanger (e.g., radiator 385). This may assure that vapor 250 is substantially returned to a liquid state before entering pump 350 and control reservoir 300. The liquid in control reservoir 300 may be then returned to boiler 200 via a path (e.g., pipe 230/390). However, as noted above, those skilled in the art will appreciate that the liquid may be returned 512 directly to boiler 200, thereby bypassing control reservoir 300.

According to one or more embodiments, when it is not desired to produce electrical power from vapor 250, bypass control valve 330 may be opened, which may allow vapor 250 to be condensed in radiator 370. According to one or more embodiments, the volume and pressure of vapor supplied to turbine 400 may be modulated by variably and/or partially opening valve 330.

According to one or more embodiments, various sensors and controls known to those skilled in the art may be included. For example, a liquid level sensor, e.g., in boiler 200, may measure a filling level (e.g., filling level 220) and may cause additional liquid working fluid 210 to be added to the system from an external supply and/or control reservoir 300 for example, to make up for incidental losses and leakage of liquid working fluid 210.

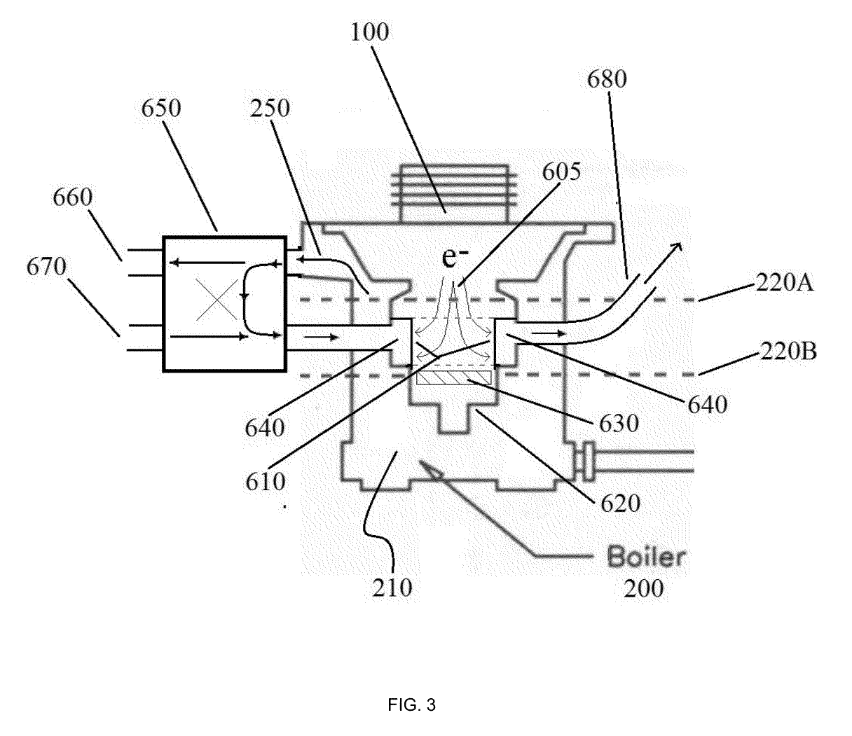

According to one or more embodiments, a class of vacuum tube devices specifically designed for production of very high temperature steam or other vaporous working fluid may be used. For example, referring at least to FIG. 3, vacuum tube 100 may be fitted to boiler 200, both of which may be substantially as described relative to FIG. 2. Vacuum tube 100 may be adapted to include two cooling zones (e.g., primary electron collector structure of anode cooling zone 610 and secondary electron collector structure of anode cooling zone 620), which may be at the same time heating zones for liquid working fluid 210.

According to one or more embodiments, surfaces of primary electron collector structure 610 and secondary electron collector structure 620 may be both at anode electrical potential and serve as electron collectors or plates of vacuum tube 100, electrically similar to anode 160 of FIG. 2. Primary electron collector structure 610 may receive the dominant share of electron flux (e.g., electron flux 605), which may be arranged to occur by electron-optical means or design of the vacuum tube. For example, according to one or more embodiments, the vacuum tube design means may include an electron repeller (e.g., electron repeller 630). Electron repeller 630 may be an electrically isolated or “floating” electrode which, upon initial conduction of current through vacuum tube 100, may receive some portion of electrons until, e.g., it charges up to a negative potential after which electrons may be substantially repelled from going further toward secondary electron collector 620 and deflected in larger portion toward primary electron collector 610.

The size and location of repeller 630 may be designed and constructed to determine the relative fraction of electrons reaching primary electron collector 610 versus secondary electron collector 620. Repeller 630 may optionally be cooled (although repeller 630 is shown uncooled), since it may receive little electron current and hence little direct dissipation of power. The design and construction of repeller 630 may be known to those skilled in the art. According to one or more embodiments, the function of repeller 630 may be accomplished by other means, as well, such as by, for example, external magnetic fields to bend electron trajectories 605 toward primary electron collector 610.

According to one or more embodiments, behind and surrounding primary electron collector 610 may be a steam heating channel (e.g., steam heating channel 640). A portion of heat generated by collection of electrons at primary electron collector 610 may flow toward steam heating channel 640 via conduction through a vacuum wall of primary electron collector 610, and another portion of the same heat may flow toward secondary electron collector 620 through the vacuum-liquid-tight wall connecting primary electron collector 610 to secondary electron collector 620.

The partitioning of the original quantity of heat among the two heat sinks (e.g., steam heating channel 640 and secondary electron collector 620) may be controlled by design, primarily of the relative wall thicknesses and the thermal conductivity of the materials of the walls. Liquid working fluid 210 in boiler 200 may become heated by heat from vacuum tube 100 and may create steam 250 (e.g., vapor 250). This may be considered the first stage of heating liquid working fluid 210.

According to one or more embodiments, vapor 250 may pass out and through a steam diverter valve (e.g., steam diverter valve 650) and may be directed into steam heating channel 640, passing over and in contact with the back side of primary electron collector 610 thus cooling vapor 250. The further heated vapor 250 may pass out of a high-temperature steam outlet (e.g., high-temperature steam outlet 680) and into the remainder of the system of FIG. 2, for example, into pipe 240. This may be considered the second stage of heating liquid working fluid 210.

Those skilled in the art will appreciate that various design choices may be made without departing from the scope of the disclosure. For example, liquid working fluid 210 may be maintained at the same or different levels within boiler 200 at 220A or 220B or other level.

According to one or more embodiments, two separate reservoirs or circuits of liquid working fluid 210 may be employed. For example, the depicted reservoir, boiler 200 with working liquid fluid 210, may be used to generate vapor 250 which is routed for use by other equipment, e.g., by steam diverter valve 650 via outlet port 660. Another reservoir and working fluid circuit, may provide vapor 250 or other gaseous working fluid to an inlet port (e.g., inlet port 670) through steam diverter valve 650 into steam heating channel 640, where it may be heated by vacuum tube 100 and subsequently directed out through a path (e.g., pipe 680) for use in other equipment.

According to one or more embodiments, vapor 250 produced when liquid working fluid 210 is used to cool vacuum tube 100 may be reheated 516 before turbine 400 (or other equipment) receives 504 vapor 250. For instance, an example use of the second heating circuit for liquid working fluid 210 within the system depicted in, e.g., FIG. 2 may be as a reheat 516 function for vapor 250 in turbine 400. For example, turbine 400 may be improved in efficiency, and/or control may be gained over condensation of vapor 250 within turbine 400, e.g., if a portion of vapor 250 passing through and driving turbine 400 is reheated 516. Vapor 250 may be reheated 516, for example, by diverting the portion of vapor 250 through a heater (e.g., heating channel 640 and primary electron collector 610) or by using heated working fluid from a heater (e.g., heating channel 640 and primary electron collector 610) in a heat exchanger local to turbine 400 to reheat 516 vapor 250 in turbine 400. It will be understood that various ports and valves associated with turbine 400 may be used to implement reheating 516 of vapor 250. According to one or more embodiments, reheating 516 of vapor 250 in turbine 400 may occur mid-stream as vapor 250 passes through turbine 400 (e.g., after vapor 250 may have cooled to a desired degree).

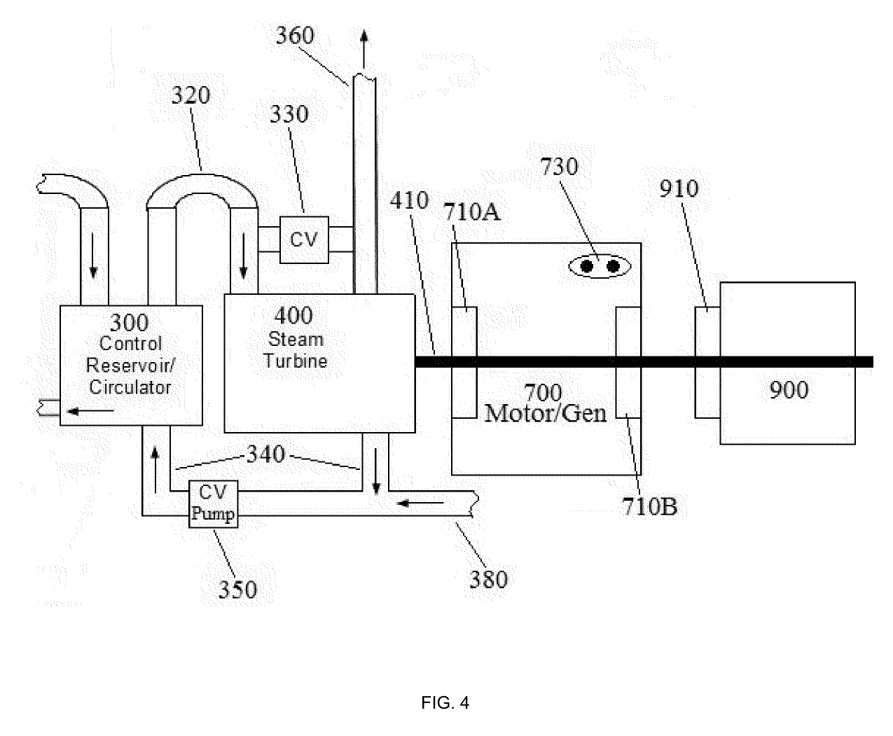

According to one or more embodiments, and referring at least to FIG. 4, a turbine shaft (e.g., turbine shaft 410) is shown to indicate, e.g., one or more loads (e.g., load 900) driven for the output power of turbine 400. As discussed throughout, load 900 may include, but is not limited to, a generator/motor (e.g., generator/motor 700), an alternator (e.g., alternator 500), or combination thereof. For example, turbine 400 may drive motor/generator 700 and/or rotary mechanical load 900.

According to one or more embodiments, one or more couplings may be configured to drive load 900 via vacuum tube 100. For example, variable coupling 710A may selectively engage a rotary armature or the like inside motor/generator 700 with shaft 410 in order to generate electrical power at an output terminal (e.g., output terminal(s) 730). According to one or more embodiments, coupling 710A may be disengaged from motor/generator 700's armature and variable coupling 910 engaged in order for turbine 400 to drive mechanical load 900 via shaft 410. According to one or more embodiments, turbine 400 may be idle, and coupling 710A may disengage completely shaft 410 and variable coupling 710B engage motor/generator 700's armature in motor mode to drive load 900 via a separate segment of shaft 410. An external electrical supply may supply input power to output terminals 730.

According to one or more embodiments, both turbine 400 and motor/generator 700 may jointly drive load 900 via appropriate selection of the state of variable couplings 710A, 710B and 910. Variable couplings 710A, 710B and 910 may include, but are not limited to, clutches, torque converters, gear boxes, other types of couplers, or combination thereof. As noted above, shaft 410 may be, for example, multi-segmented along its length, or one solid shaft. According to one or more embodiments, motor/generator 700 may be used as a power-generative brake for, e.g., either turbine 400 or load 900, producing output power at output terminals 730.

According to one or more embodiments, the term “vacuum tube”, as used herein, may include all styles of such devices, including but not limited to, amplifiers, rectifiers, switches, modulators, regulators, pulsers, beam dumps, and the like. Vacuum tubes described by their number of electrodes, for example, diodes, triodes, tetrodes, pentodes, etc. may be considered as well. Furthermore, the term “vacuum” tube is not intended to be limiting, but is indicative of where a partial vacuum may be found useful for generation, transport and collection of unbound (free) atomic-scale particles (e.g., electrons), which may be accelerated or repulsed by electric and magnetic fields and potentials. Therefore, the term vacuum tube may include other, non-vacuum media in which similar control of substantially free charged particles may be practiced. Similarly, the term vacuum “tube” is understood to include substantially free charged particle control devices that may not be built inside a tube or vessel but may be arranged differently. All of these different devices may be included herein in the meaning of the term “vacuum tube”.

As will be appreciated by one skilled in the art, the present disclosure may be embodied as a method, system/apparatus, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. The computer-usable, or computer-readable, storage medium (including a storage device associated with a computing device or client electronic device) may be, for example, but not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of this document, a computer-usable or computer-readable, storage medium may be any tangible medium that can contain or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable program code may be transmitted using any appropriate medium, including but not limited to the internet, wireline, optical fiber cable, RF, etc. A computer readable signal medium may be any computer readable medium that is not a computer readable storage medium and that can communicate, propagate, or transport a program for use by or in connection with an instruction execution system, apparatus, or device.

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by one or more computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or combinations thereof.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

The computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The embodiment(s) were chosen and described in order to best explain the principles of the disclosure and the practical application, and to enable others of ordinary skill in the art to understand the disclosure for various embodiment(s) with various modifications and/or any combinations of embodiment(s) as are suited to the particular use contemplated.

Having thus described the disclosure of the present application in detail and by reference to embodiment(s) thereof, it will be apparent that modifications, variations, and any combinations of embodiment(s) (including any modifications, variations, and combinations thereof) are possible without departing from the scope of the disclosure defined in the appended claims.

What is claimed is:

1. An apparatus, comprising:
a device configured to produce heat during operation;
a first container configured to hold a fluid used to cool at least a portion of the device during operation, wherein the fluid, when used to cool at least the portion of the device, produces vapor; and
an electrical generating device configured to receive at least a first portion of the vapor produced when the fluid is used to cool at least the portion of the device, wherein the electrical generating device, when at least the first portion of the vapor produced when the fluid is used to cool at least the portion of the device is received, is further configured to convert into electrical energy at least the first portion of the vapor produced when the fluid is used to cool at least the portion of the device.

2. The apparatus of claim 1 further comprising a second container configured to hold at least the first portion of the vapor produced when the fluid is used to cool at least the portion of the device, wherein the second container includes a control valve configured to force into the electrical generating device at least the first portion of the vapor produced when the fluid is used to cool at least the portion of the device.

3. The apparatus of claim 1 further comprising a path configured to return at least a portion of condensed vapor produced from at least the first portion of the vapor back to the first container.

4. The apparatus of claim 1 further comprising a path configured to allow at least a portion of condensed vapor produced from at least the first portion of the vapor to escape from the electrical generating device.

5. The apparatus of claim 1 wherein at least the first portion of the vapor produced when the fluid is used to cool at least the portion of the device is reheated before the electrical generating device receives at least the first portion of the vapor produced when the fluid is used to cool at least the portion of the device.

6. The apparatus of claim 1 further comprising one or more couplings configured to drive a load via the device.

7. The apparatus of claim 6 wherein the load includes at least one of a generator, a motor, and an alternator.

8. An apparatus, comprising:
a vacuum tube configured to produce heat during operation;
a boiler configured to hold a fluid used to cool at least a portion of the vacuum tube during operation, wherein the fluid, when used to cool at least the portion of the vacuum tube, produces vapor; and
a turbine configured to receive at least a first portion of the vapor produced when the fluid is used to cool at least the portion of the vacuum tube, wherein the turbine, when at least the first portion of the vapor produced when the fluid is used to cool at least the portion of the vacuum tube is received, is further configured to convert into electrical energy at least the first portion of the vapor produced when the fluid is used to cool at least the portion of the vacuum tube.

9. The apparatus of claim 8 further comprising a reservoir configured to hold at least the first portion of the vapor produced when the fluid is used to cool at least the portion of the vacuum tube, wherein the reservoir includes a control valve configured to force into the turbine at least the first portion of the vapor produced when the fluid is used to cool at least the portion of the vacuum tube.

10. The apparatus of claim 8 further comprising a path configured to return at least a portion of condensed vapor produced from at least the first portion of the vapor back to the boiler.

11. The apparatus of claim 8 further comprising a path configured to allow at least a portion of condensed vapor produced from at least the first portion of the vapor to escape from the turbine.

12. The apparatus of claim 8 wherein at least the first portion of the vapor produced when the fluid is used to cool at least the portion of the vacuum tube is reheated before the turbine receives at least the first portion of the vapor produced when the fluid is used to cool at least the portion of the vacuum tube.

13. The apparatus of claim 8 further comprising one or more couplings configured to drive a load via the vacuum tube.

14. The apparatus of claim 13 wherein the load includes at least one of a generator, a motor, and an alternator.

15. A method, comprising:
producing heat from a device during operation;
holding, in a first container, a fluid used to cool at least a portion of the device during operation, wherein the fluid, when used to cool at least the portion of the device, produces vapor;
receiving, by an electrical generation device, at least a first portion of the vapor produced when the fluid is used to cool at least the portion of the device; and
converting, at least in part by the electrical generation device when at least the first portion of the vapor produced when the fluid is used to cool at least the portion of the device is received, into electrical energy at least the first portion of the vapor produced when the fluid is used to cool at least the portion of the device.

16. The method of claim 15 further comprising:
holding at least the first portion of the vapor produced when the fluid is used to cool at least the portion of the device; and
forcing into the electrical generation device at least the first portion of the vapor produced when the fluid is used to cool at least the portion of the device.

17. The method of claim 15 further comprising returning back to the first container at least a portion of condensed vapor produced from at least the first portion of the vapor.

18. The method of claim 15 further comprising allowing at least a portion of condensed vapor produced from at least the first portion of the vapor to escape from the electrical generation device.

19. The method of claim 15 further comprising reheating, before the electrical generation device receives at least the first portion of the vapor produced when the fluid is used to cool at least the portion of the device, at least the first portion of the vapor produced when the fluid is used to cool at least the portion of the device.

20. The method of claim 15 wherein one or more couplings drive a load via the device.

21. The method of claim 20 wherein the load includes at least one of a generator, a motor, and an alternator.
